(19) United States
(12) Patent Application Publication
(10) Pub. No.: US 2025/0262039 A1
(43) Pub. Date: Aug. 21, 2025

(54) ORAL QUADRENT ISOLATING SUCTION DEVICE

(71) Applicant: Hari Reyes, Ridgefield, WA (US)

(72) Inventor: Hari Reyes, Ridgefield, WA (US)

(73) Assignee: Dental Holdings LLC, Beaverton, OR (US)

(21) Appl. No.: 18/444,578

(22) Filed: Feb. 16, 2024

(51) Int. Cl. A61C 17/06

(52) U.S. Cl. CPC A61C 17/06

(57) ABSTRACT

A oral suction device that incorporates a foldable suction body, a bite block and a suction adapter that is utilized to block the throat cavity. The body draws water, saliva and debris from about a gap along its outer perimeter. The suction body resides in a vertical position in the patient's mouth and is able to expand to allow the transport of large pieces of debris without coming apart. There is a fishtail section of the suction body that anchors it between the teeth and the inner cheek so as to allow the remained of the suction body to block the throat hole.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to an oral suction device for use in dental practice.

### BACKGROUND

Often dental work incorporates numerous dental tools/aids such that the patient's mouth is a crowed area for the dentist to work in. Also, many dental procedures work most efficiently and comfortably, when there is a constant suction applied. In such cases the application of timed manual suction by the dental technician is counter-productive, and the retention of conventional suction devices in the mouth just occupies valuable space.

Prior art devices draw water, saliva and debris through orifices in a suction body. This leads to blockage and collapse of the suction body. To prevent such suction collapse, as well as to be rigid enough to maintain their positioning in the patient's mouth, these suction bodies are quite stoutly fabricated and stand slightly away from the patient's teeth.

Henceforth, a dental suction device that can isolate a quadrant of the patient's mouth while the dentist worked in a specific area, would fulfill a long felt need in the dental industry. This new invention utilizes and combines known and new technologies in a unique and novel configuration to overcome the aforementioned problems and accomplish this. Thus, a more controllable and consistent suction solution is provided by the embodiments set forth below.

### BRIEF SUMMARY

In accordance with various embodiments, an oral suction device is provided.

In one aspect, an oral suction device that can be operated in a vertical orientation is provided.

In another aspect, a thin profile, trimable oral suction device that contours to the cheek and resides adjacent the upper and lower teeth on one side of the mouth, is provided.

In yet another aspect, an oral suction device that can be coupled to a bite block is provided.

In yet another aspect, an oral suction device that can be oriented for left cheek or right cheek operation, to isolate the quadrants of the mouth is provided.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components.

FIG. 1 is a side perspective view of the open, hinged suction body;

FIG. 2 is a side perspective view of the closed, hinged suction body;

FIG. 3 is a side perspective view of the folded hinged suction body;

FIG. 4 is a top view of the open, hinged suction body;

FIG. 5 is a side view of the open, hinged suction body;

FIG. 6 is a bottom view of the open, hinged suction body;

FIG. 7 is a proximal end view of the open, hinged suction body;

FIG. 8 is a distal end view of the open hinged suction body;

FIG. 9 is a side perspective view of the suction adapter;

FIG. 10 is a top view of the suction adaptor;

FIG. 11 is a front end view of the suction adaptor;

FIG. 12 is a side view of the suction adaptor;

FIG. 13 is a back end view of the section adaptor;

FIG. 14 is a bottom view of the suction adaptor;

FIG. 15 is a side perspective view of the bite block;

FIG. 16 is a top view of the bite block;

FIG. 17 is a front view of the bite block;

FIG. 18 is a left and right side view of the bite block;

FIG. 19 is a back view of the bite block;

FIG. 20 is a bottom view of the bite block;

FIG. 21 is an exploded side perspective view of the suction device; and

FIG. 22 is an assembled side perspective view of the suction device.

### DETAILED DESCRIPTION OF CERTAIN EMBODIMENTS

Reference will now be made in detail to embodiments of the inventive concept, examples of which are illustrated in the accompanying drawings. The accompanying drawings are not necessarily drawn to scale. In the following detailed description, numerous specific details are set forth to enable a thorough understanding of the inventive concept. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

The terminology used in the description of the inventive concept herein is for the purpose of describing particular embodiments only and is not intended to be limiting of the inventive concept. As used in the description of the inventive concept and the appended claims, the singular forms “a,” “an,” and “the” are intended to include the plural forms as well, unless the context clearly indicates otherwise.

In the following description, for the purposes of explanation, numerous specific details are set forth in order to provide a thorough understanding of the described embodiments. It will be apparent to one skilled in the art, however, that other embodiments of the present invention may be practiced without some of these specific details. It should be appreciated that the features described with respect to one embodiment may be incorporated with other embodiments as well. By the same token, however, no single feature or features of any described embodiment should be considered essential to every embodiment of the invention, as other embodiments of the invention may omit such features.

As used herein, the terms “closed” and “folded” both mean a configuration of the vacuum body where both the plates (the first plate and the fishtail plate) are connect by their two locking stubs to form a void therebetween, the void having a central vacuum channel formed thereon.

As used herein, the terms “open” and “flat” both mean a configuration of the vacuum body where both the plates (the first plate and the fishtail plate) are not connected, and their planar faces lie in a common plane.

The present invention relates to a novel design for an oral suction device intended to be comfortable, create a block across the throat opening, secure itself between the cheek and teeth on one side of a patient's mouth, and provide continual suction with a minimal presence. It is intended primarily for the dental restorative market where protecting the airway and tongue is important during all restorative procedures. Simply stated, by inserting a fishtail tightly between the teeth and cheek, it blocks the throat opening and allows for the isolation of one side of the mouth.

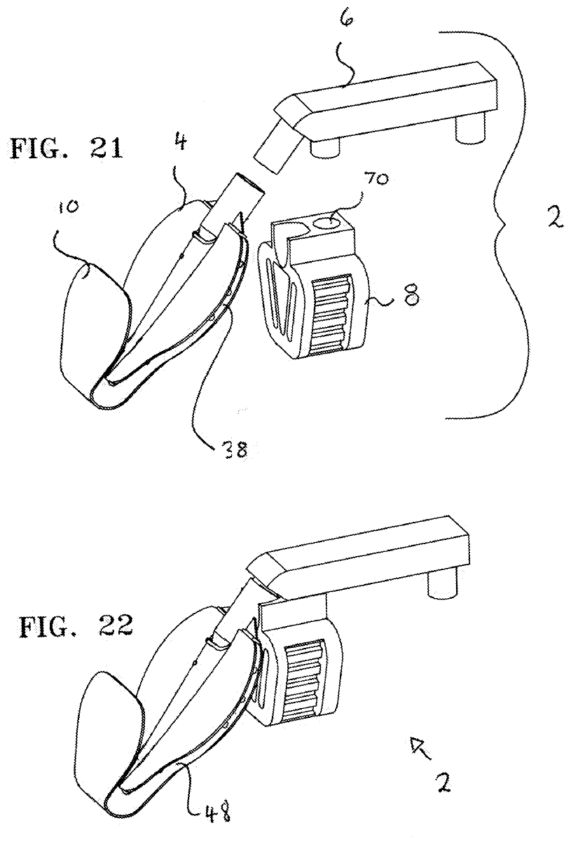

The oral suction device 2 (FIGS. 21 and 22) It has three elements, a suction body 4, a suction adaptor 6 and a bite block 8, although the bite block 8 need only be used when warranted. In use, its suction body 4 is intended to reside vertically in a patient's mouth with a fishtail section 10 retained between the outer side of upper and lower teeth on the right or left side of the mouth, and the left or right inner cheek. The entire device 2 is anchored in position there by two things: a tail section 10 that fits between the check and the outer side of the teeth, and a suction created between the suction body 4 and the roof of the mouth and the tongue.

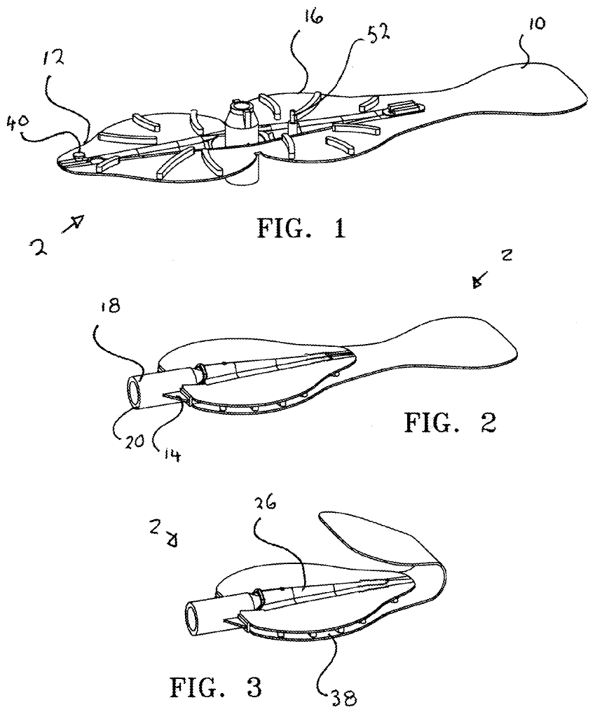

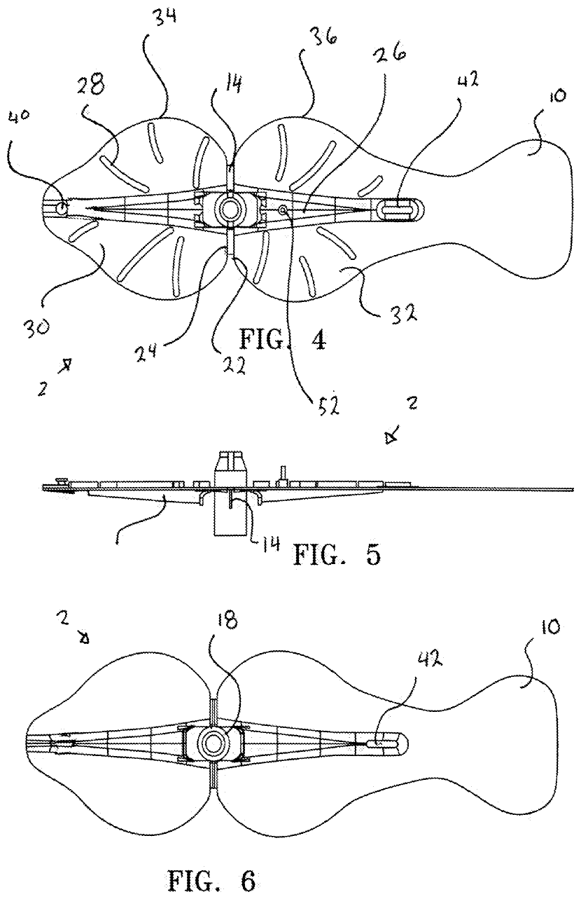

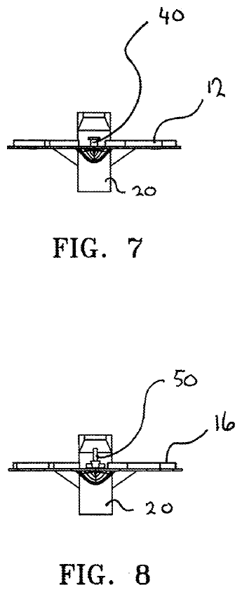

Looking at FIGS. 1 to 8, the suction body 4 can best be explained. It is comprised of a first, flexible planar plate 12 that is hingedly attached by a two-part living hinge 14 to a second, flexible planar fishtail plate 16. Disposed centrally, and perpendicularly between the two plates 12 and 16 is a cylindrical suction stub 20 having both halves of the living hinge 14 extending normally from its side walls 18 at 180 degrees apart and connected to the distal ends 22 and 24 of both plates. The suction stub 20 resides along the longitudinal centerline of the device 2. Each of the plates 12 and 16 have a central longitudinal vacuum channel 26 and series of raised, curved spacers 28 formed thereon their inner faces 30 and 32. These spacers 28 extend between the peripheral edges 34 and 36 of the plates 12 and 16 and the vacuum channel 26 to create and sustain a void 48 between the two folded plates 12 and 16 when folded and under suction. These spacers 28 radially curve toward the plates' distal hinged ends 22 and 24 and the suction stub 20. These spacers 28 act to hold the two plates 12 and 16 in a spaced, separated configuration, and to funnel water, saliva and debris from the perimeter of the suction body 4 into the vacuum channel 26 and the suction 20, when the two plates 12 and 16 are folded and locked together. When folded, the suction stub 20 extends beyond the peripheral edge of the two plates 12 and 16 at their midline, and into the distal end of the vacuum channel 26 in the void 38 created between the two plates 12 and 16.

The first plate 12 has a first locking stub 40 adjacent its distal end that frictionally engages an oblong locking slot 42 in the fishtail plate 16 when the two plates 12 and 16 are folded about their living hinge 14. The oblong locking slot 42 allows for movement between the two plates 12 and 16 caused by larger chunks of debris passing through the suction channels 38 between the spacers 28 and vacuum channel 26 without disengaging the locking stub 40. As debris is sucked in and passes through the suction body 4, the void between the plates 48 increases and the plates 12 and 16 rise up and shorten in length which would pop the first locking stub 40 if it were not in the oblong locking slot 42 which allows the locking stub 40 to travel longitudinally and not dislodge.

There is a second locking stub 50 extending from the inner face 32 of the fishtail plate 16 that mechanically engages a locking orifice 52 in the first plate 12. This mechanical engagement is located adjacent to the suction stub 20 and serves to hold the two plates 12 and 16 together. The two plates 12 and 16 are complimentary in their configurations when folded together, although the first plate 12 is marginally smaller (less than 10%) and has a smaller perimeter than the fishtail plate 16.

The second plate 16 has a flexible fishtail extension 10 formed at its non-hinged end. This fishtail extension 10 is planar and unadorned. FIG. 3 illustrates how the fishtail extension 10 is flexed to fit between the outer side of the teeth and the cheek. It is important to note that the two plates 12 and 16 have no evacuation orifices therethrough for the vacuuming of water, saliva and debris. Rather, all vacuuming occurs from opening into the void 48 at the peripheral edge 34 and 36 of the plates 12 and 16 when folded together. All vacuuming is done from the bottom peripheral gap while the top peripheral gap aids to suck and secure the device to the roof of the patient's mouth so it does not fall into the center of the mouth given its extremely thin, flexible configuration. When the two plates 12 and 16 are folded, a gap is formed between them at their peripheral edges 34 and 36 where the void 48 begins. This gap is maintained from vacuum collapse by the curved spacers 28 that extend from the vacuum channel 26 to the peripheral edges 34 and 36 of each plate 12 and 16, and because these peripheral edges 34 and 36 of the two plates do not reside directly aligned with one another by virtue of the discrepancy in size of the peripheral edges of the two plates 12 and 16. The face of the void 48 is angled with respect to the plane of either of the plates 12 and 16. This is a vast improvement over the prior art. The lack of orifices on the faces of the two plates 12 and 16, allow for a greater suction at the perimeter of the suction body 4. This helps to secure the suction body 4 to the roof of the mouth and to direct the full suction to the bottom of the mouth where the saliva, water and debris pool. The prior art's orifices serve to draw in air to the suction body 4 and reduce the level of vacuum available for suction where is needed the most.

The two-plate planar configuration with the central suction stub 20 allows inexpensive, simple injection molding. This allows the suction body 4 to be disposable, cheap and scalable. To use it on the other side of the mouth it need only be flipped 180 degrees. The absence of vacuum holes through the vacuum body prevents blockage and the sliding locking tab 42 accommodates the passage of large pieces of debris into the vacuum channel 26 because of increase suction at the perimeter of the suction body 4. The sliding locking tab 42 also allows the suction body 4 to be curved to different degrees without buckling and to be opened for cleaning. These novel improvements overcome four of the major problems with prior art oral suction devices. The material of choice for the vacuum body 4 is a thermal formed elastomer (TFE). It has a material stiffness of less than 60 on the Shore 00 durometer scale of hardness.

The suction body 4 is extremely thin, and when closed, being approximately 3.35 mm thick (+/−0.3 mm). Each of the two plates 12 and 16 are 1 mm thick +/−(0.1 mm). This thickness of material having a durometer of less than 60 on the Shore 00 scale, allows for the vacuum body 4 to be trimmed to fit in smaller patient's mouths, by a pair of scissors. The curved spacers 28 are 1.35 mm high (+/−0.1 mm), and 1.2 mm thick (+/−0.1 mm). This is a reduction in material alone, of approximately 90% over prior art devices. The suction body 4 is intended to be disposable.

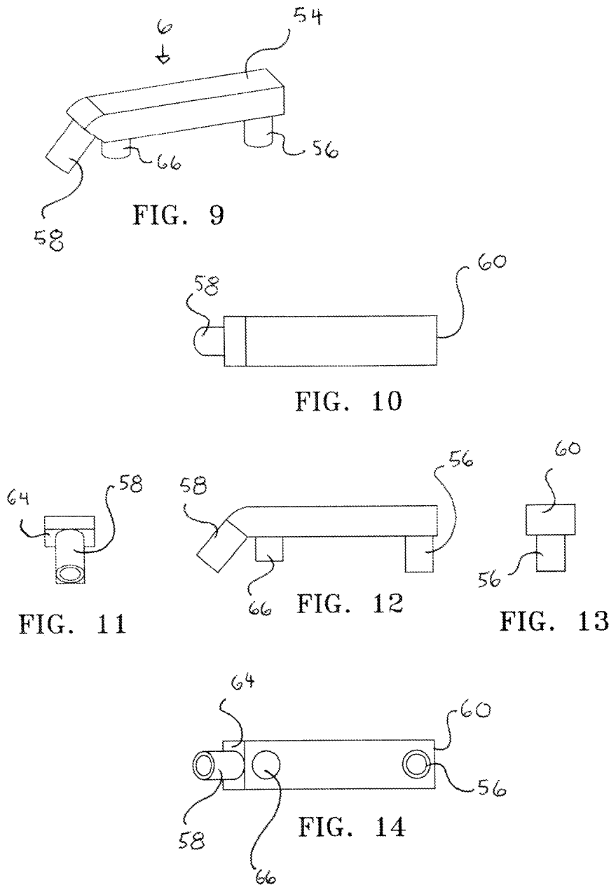

Looking at FIGS. 9 to 14 with reference to FIGS. 21 and 22, the suction adapter 6 can best be explained. The suction adapter 6 is a device that provides suction to the suction body 4 from a hose connected to the local vacuum unit in the dentist's office, (The hose connects and resides alongside the exterior of the patient's cheek.) The suction adaptor is also intended to be disposable.

The suction adaptor 6 is an enclosed rectangular cylinder body 54 with an angled front face 64 and a rear face residing perpendicular to the side walls of the adaptor 6. It has a suction outlet fitting 56 extending perpendicularly from the bottom side wall 62 of the body 54 adjacent its distal end 60, a suction inlet fitting 58 extending perpendicularly from the angled front face 64 of the body 54, and an attachment peg 66 extending from the bottom side wall 62 of the body 54 adjacent the suction inlet fitting 58. The attachment peg 66 is a solid round cylindrical stub, sized for frictional engagement with the mounting orifice 70 of the bite block 8. (FIG. 15) The suction outlet fitting 56 is a hollow round cylindrical tube sixed for frictional engagement with the suction/vacuum line from a localized vacuum pump. (not illustrated) The suction inlet fitting 58 is a hollow round cylindrical tube sized for frictional engagement with the suction stub 20 of the suction body 4. All three of the projections from the body of the suction adapter reside on the angled front face 64 or the bottom side wall 52. In this way the suction adapter may reside outside the patient's mouth and direct the suction line alongside the patient's outside cheek, the bite block 8 between the patient's upper and lower teeth, and the suction body 4 inside the patient's mouth, disposed on one side of the bite block 8 across the throat opening and between the patient's teeth and cheek. This configuration blocks one side of the patient's teeth, their throat opening, and locks between the teeth on the other side of the mouth and the adjacent inner cheek. This configuration is seen in FIGS. 21 and 22. The suction adaptor 6 is made of an autoclavable polymerout of a TPE preferably having a durometer of 85-95 on the Shore D Scale of hardness.

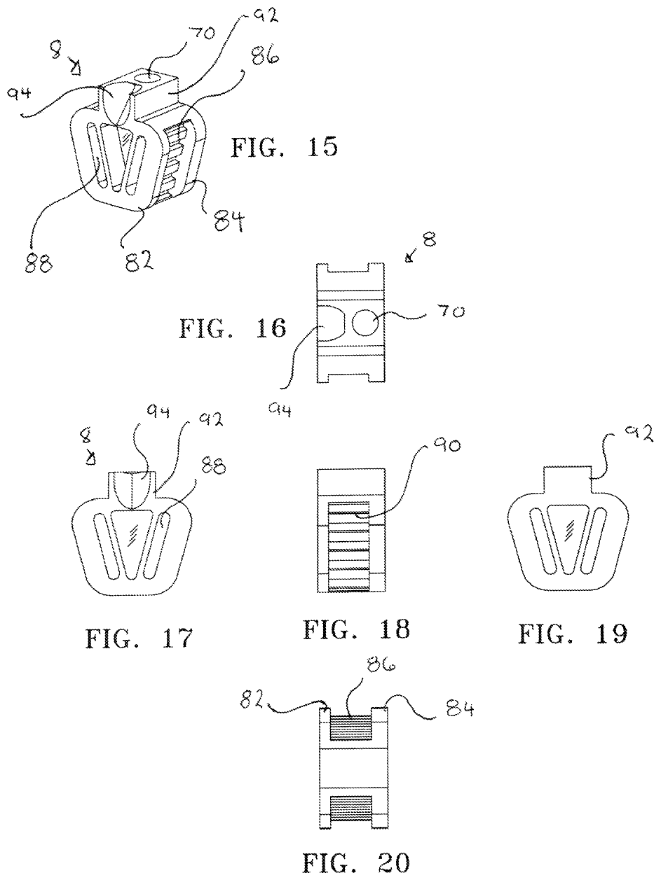

The bite block 8 is best explained with reference to FIGS. 15 to 20. It has a generally shaped as a trapezoidal prism. It is a rigid polymer body of a pair of first and second generally trapezoidal plates 82 and 84 held in a parallel spaced configuration by a ribbed central body 86. The ribs 90 serve as grips for the patient's teeth. The non-parallel sides of the trapezoidal plates 82 and 84 extend beyond the central body 86. At the top of the bite block 8 there is a connector section 92 that has a mounting orifice 70 formed therein, and an angled support saddle 94 that the suction stub 20 resides atop for the alignment and support of the suction body 4. There are compression slots 88 formed through the body 86 that allows the body 86 to compress and collapse inward slightly under bite pressure. The bite block is a reusable, autoclavable item and is made from a polymer having a material stiffness of greater than 40 on the Shore A durometer scale of hardness, preferably it will be in the range of 85-95 on Shore D Scale of hardness.

Looking at FIGS. 21 and 22 the complete oral suction device 2 with the optional bite block 8 is best illustrated. A suction adaptor 6 has its attachment peg 66 engaged into the mounting orifice 70 of the bit block 8. A suction/vacuum line from a localized vacuum pump is frictionally engaged with the suction outlet fitting of the suction adaptor 6. The cylindrical suction stub 20 of the vacuum body 4 is frictionally engaged with the suction inlet fitting 56 on the suction adaptor such that the suction stub lies in and is supported by the support saddle 94 of the bite block. The first plate 12 faces the center of the patient's mouth. The device 2 is inserted into the patient's mouth such that the planar faces of the suction body 4 reside perpendicular to the roof of the patient's mouth and the suction body 4 blocks the patient's throat opening. The fishtail extension 10 is placed between the patient's inner cheek and teeth and the patient bites down onto the ribbed central body 86 of the bite block 8. The vacuum/suction pump may now be started or switched open to the device 2. The suction will draw the device 2 to the roof of the patient's mouth and to the top of the tongue. Suction will draw water, saliva and debris from the bottom of the patient's mouth through the void 48 between the two folded plates 12 and 16 and into the central vacuum channel 26 such that it can exit the device through the suction stub 20, and the suction adapter 8.

When large pieces of debris are drawn to the perimeter of the suction body 4, the increased suction will pull the debris into the void 48 of the suction body 4 by allowing the two plates 12 and 16 to rise and separate slightly (beyond its 1.35 mm size) to accommodate the volume of the debris as it passes between the curved spacers 28 and into the suction channel 26. As the plates 12 and 16 separate, the device 2 will shorten somewhat, and the first locking stub 40 will move long the oblong locking slot 42 but still maintaining the connection between the two plates 12 and 16. As the debris passes through the vacuum channel 26, the two plates 12 and 16 flatten as the locking stub slidingly returns to its earlier position in the oblong locking slot 42 and the two plates 12 and 16 are again drawn into their close proximity, and the void thickness of approximately 1.35 mm is again maintained by the height of the spacers 28. In the event that there is a blockage of the vacuum channel 26, the device 2 can be retrieved from the patient's mouth, opened and the debris removed.

It is envisioned that the suction body 4 will be available in three sizes only as they are trimable. There will only be one suction adapter 6 and the bite block 8 will be available in three color coded sizes.

While certain features and aspects have been described with respect to exemplary embodiments, one skilled in the art will recognize that numerous modifications are possible. Consequently, in view of the wide variety of permutations to the embodiments described herein, this detailed description and accompanying material is intended to be illustrative only, and should not be taken as limiting the scope of the inventive concept. What is claimed as the invention, therefore, is all such modifications as may come within the scope and spirit of the following claims and equivalents thereto.

Having thus described the invention, what is claimed as new and desired to be secured by Letters Patent is as follows:

1. An oral suction device intended for connection to an external suction source and used to block the throat opening in a patient's mouth for restorative dental work, comprising:
a trimable, suction body formed from the assembly of two flexible, hinged plates, a first plate and a fishtail plate, that create a void therebetween that terminates about a perimeter of said assembly of plates making a suction body single suction inlet gap;
an optional bite block adapted for engagement with a patient's teeth to hold said suction member vertically oriented within said patient's mouth;
a hollow suction adapter connected to said suction body and connectable to said optional bite block.

2. The oral suction device of claim 1 further comprising:
an oblong locking slot formed through said suction body; and
a locking stud, residing in said void of said suction body, said locking stud slidingly engageable is said oblong locking slot.

3. The oral suction device of claim 1, further comprising:
a second locking stud residing in said void of said suction body and frictionally engageable in a complimentary sized locking orifice formed through said suction body.

4. The oral suction device of claim 3, further comprising:
a hollow, cylindrical suction stub residing between said two hinged plates, said suction stub having a two-part living hinge extending normally therefrom, said living hinge connected to said first plate and said fishtail plate; and
wherein said suction stub has a proximal end that extends into a suction channel in said suction body, and a distal end connected to said suction adaptor.

5. The oral suction device of claim 4, further comprising:
a series of spacers formed on an inner face of said first plate, and on an inner face of said fishtail plate, said spacers extending between said vacuum channel and said perimeter of said assembly of plates.

6. The oral suction device of claim 5, further comprising:
a connector section formed on said bite block, said connector section having a mounting orifice formed therein, and an angled support saddle formed thereon that said suction stub resides atop for alignment and support of said suction body.

7. The oral suction device of claim 1 wherein said first plate and said fishtail plate have different sized peripheral edges that do not reside in alignment when said suction body is closed.
